(19) United States
(12) Patent Application Publication
(10) Pub. No.: US 2002/0191589 A1
(43) Pub. Date: Dec. 19, 2002

(54) Method for synchronizing call signaling and voice circuit setup over a voice over internet protocol network

(76) Inventor: Dimitrios Vassiliou, Salamis (GR)

Correspondence Address: Kevin R. Spivak, Morrison & Foerster LLP, Suite 5500, 2000 Pennsylvania Avenue, N.W., Washington, DC, 20006-1888, US

(21) Appl. No.: 10/133,651

(22) Filed: Apr. 29, 2002

(30) Foreign Application Priority Data
Apr. 27, 2001 (EP) 01110500.4

(51) Int. Cl. H04L 12/66; H04L 12/28

(52) U.S. Cl. 370/352; 370/401

(57) ABSTRACT

The present invention provides a method for synchronizing call signaling and voice circuit setup in a telephone call between an initiating and destination PSTN switch passing through a packet switched network. The packet switched network has Media Gateways (MGs) that interface with the PSTN switches through voice trunks, and Media Gateway Controllers (MGCs) that control and instruct the MGs. The PSTN switches send Signaling System 7 (SS7) call signaling messages to each other through the MGC. To synchronize the call signaling and voice circuit setup, the MGC delays the effect of these SS7 messages until the MGs are initialized using Media Gateway Control Protocol (MGCP) commands. This delay is achieved by modifying the messages from the initiating switch, by imposing some requirements for the destination switch, such that the destination switch is forced to delay seizing the voice trunk from its side until further commands are sent from the MGC.

### BACKGROUND

The present invention relates to the field of Voice over IP (VoIP) networks. More specifically, the present invention relates to a method for synchronizing call signaling and voice circuit setup in case of calls over a VoIP network.

When two users communicate using a telephone, their voice is carried over telephone networks known as Public Switched Telephone Networks (PSTNs). Typically, when one user places a call to another user through the PSTN, a path is setup from the calling users' telephone to the calling user's Local Exchange (LE). Then, a path is setup from the calling user's LE to the called user's LE, through one or more intermediary telephone exchanges. And thereafter, a path is setup from the called users' LE to the called users' telephone. These paths thus setup are collectively known as a “circuit” between the calling and called users. This circuit is reserved for the entire duration of the call, and is used for carrying the voice conversation between the two users. To place calls between many users, the PSTN exchanges switch from one circuit to another; and hence PSTNs are known as “circuit switched” networks, and the PSTN exchanges are known as “switches”.

Apart from carrying voice conversations between various users, PSTNs also perform various other functions. These are functions such as “finding” a circuit between a calling telephone and the called telephone, “setting up” a circuit between the two telephones, and “tearing down” a circuit after a call has terminated. In addition to these functions, PSTNs also perform functions such as providing a “dial tone” to its users, collecting digits dialed by the users, and providing users access to their respective voice mailboxes.

In order to perform functions such as the above-mentioned, various PSTN components such as the telephones, switches and other networking equipments have to communicate with each other. This communication between components is achieved using the concept of “call signaling”. Call signaling refers to any protocol that defines messages which can be sent from one PSTN component to another PSTN component, in order to enable communication between them.

Using call signaling, when one user places a call to another user, the calling users' Local Exchange (switch) uses call signaling messages to setup a circuit between itself and the called users' Local Exchange (switch). Once this circuit is setup, voice signals (encoded voice conversation) are transmitted over it. During the initial days of telephony, call-signaling messages and voice signals were sent on the same circuit. Such an approach was known as “in-band signaling” or Channel Associated Signaling (CAS). However, the in-band signaling approach had a drawback that even during the phase when a circuit is being setup, precious bandwidth is wasted for carrying the signals. Thus, even if a called users' telephone is busy, a circuit between the calling user and the called user is unnecessarily reserved, as the call signals are traveling on that circuit.

Due to drawbacks such as the above mentioned, the in-band signaling approach was replaced by “out-of-band signaling” or Common Channel Signaling (CCS). In CCS, the call signals are carried over a separate path, known as a “signaling link”, which is independent of the voice carrying circuit. Thus, the voice circuit is reserved only after both the users' telephones are ready. An implementation of CCS, known as Signaling System No 7 (SS7), is now a well accepted signaling system. SS7 defines a network known as an SS7 network, and a protocol known as an SS7 protocol.

An SS7 network has two essential components—Signal Switching Points (SSPs), which are PSTN switches; and Signal Transfer Points (STPs), which are switches that receive and route signaling messages from one point to another of an SS7 network.

When a PSTN uses an SS7 network for carrying call signals, the PSTN switches are the SSPs. These SSPs connect directly, either to telephones or to other SSPs, and use the STPs for transmitting call signals between them. The SSPs send call signals to the STPs, and the STPs route these call signals to other STPs or to the destination SSP. The call signals sent from one SSP to another SSP are defined by the SS7 protocol.

The SS7 protocol defines various call signaling messages; which are exchanged between two SSPs to reserve a voice circuit between them. Some of these messages are Initial Address Message (IAM), Address Complete Message (ACM), Answer Message (ANM), Continuity Message (COT), and Subsequent Address Message (SAM).

FIG. 1 is a block diagram illustrating a typical PSTN architecture that uses an SS7 network for call signaling. In FIG. 1, User A 111 and User B 113 are connected to switches SSP A 101 and SSP B 109 respectively. SSP A 101 and SSP B 109 are connected to each other through a call signaling link “STP 1 103-STP 2 105-STP 3 107”. Further, SSP A 101 and SSP B 109 are directly connected through a voice trunk, which is a high bandwidth link between the two SSPs. A voice trunk has many voice circuits within it, and is thus capable of carrying multiple voice conversations between the two SSPs. Voice trunks are part of the PSTN and do not play any role in carrying SS7 signaling messages.

When User A 111 makes a call to User B 113, SSP A 101 and SSP B 109 must reserve a voice circuit within the voice trunk using call signaling messages. An exemplary sequence of SS7 messages exchanged between the two SSPs is described below.

When User A 111 dials the digits to place a call to User B 113, SSP A 101 collects these dialed digits. SSP A 101 then analyzes these collected digits and determines that it needs to reserve a voice circuit between itself and SSP B 109. Next, SSP A 101 selects a voice circuit between itself and SSP B 109, and creates an Initial Address Message (IAM), which is an SS7 message that initiates the voice circuit setup. This IAM is addressed to SSP B 109, and contains information identifying the initiating switch (SSP A 101), the destination switch (SSP B 109), the voice circuit selected, and the calling as well as the called numbers. After creating the IAM, SSP A 101 picks up its signaling link “STP 1 103-STP 2 105-STP 3 107”, and transmits the message over this link to SSP B 109.

Upon receiving the IAM, SSP B 109 analyzes this message, and determines that the number being called is not busy. SSP B 109 then creates an Address Complete Message (ACM), which is an SS7 message that indicates that the IAM has reached its proper destination. This message contains information identifying the destination switch (SSP A 101), the initiating switch (SSP B 109), and the voice circuit selected. Next, SSP B 109 picks up its signaling link “STP 3 107-STP 2 105-STP 1 103”, and transmits the ACM over this link to SSP A 101. At the same time, SSP B 109 “seizes” (reserves) the voice circuit from its end and sends a ringing tone to SSP A 101. Then SSP B 109 connects User B 113 to this voice circuit, and rings the telephone of User B 113.

Upon receiving the ACM, SSP A 101 seizes the voice circuit from its end and connects User A 111 to this voice circuit. Now User A 111 can hear the ringing tone sent by SSP B 109 as there is a voice circuit between itself and SSP B 109. When User B 113 picks up the phone, SSP B 109 creates an Answer Message (ANM), which contains information identifying the destination switch (SSP A 101), the initiating switch (SSP B 109), and the voice circuit selected. Next, SSP B 109 selects the same signaling link it used to transmit the ACM, and sends the ANM over this link. When SSP A 101 receives the ANM, it ensures that User A 111 is connected to the voice circuit in both directions and that the conversation can take place. This completes the voice path setup.

The example given above illustrates how a voice circuit is typically setup between two PSTN switches, using SS7 messages. As mentioned earlier, the voice circuit is reserved by the PSTN switches for the entire duration of the call. However, such a circuit reservation typically results in a lot of bandwidth wastage. For example, in a telephone conversation between two users, while one user is talking the other user is usually listening. In such a case, half the voice circuit bandwidth between the two users remains unused. If the switches had not reserved this circuit, other callers could have simultaneously used this circuit. Such a bandwidth wastage also occurs because for a substantial portion of the telephone conversation, no user is talking. Again, this leads to a substantial wastage of voice circuit bandwidth, which could have been otherwise used.

Bandwidth wastages such as the above have led to attempts at replacing the circuit switched network of the PSTN with “packet switched” networks. A packet switched network, unlike a circuit switched network, does not reserve a circuit between two users for the duration of their call. When two users communicate over a packet switched network, the equipment at the sending-end breaks their messages into small chunks, known as “packets”, and sends them across the network. When the receiving-end equipment receives these packets, it reassembles them to form the original messages. Thus, the packet switched network is used for communication only for the duration that each packet is transmitted over the network; and hence packet switched networks efficiently utilize their available bandwidth.

A packet switched network, which uses a collection of protocols such as Internet Protocol (IP), Real Time Protocol (RTP) and Resource Reservation Protocol (RSVP) for placing a telephone call between two users, is called a Voice over Internet Protocol (VoIP) network.

When one user places a call to another user through a VoIP network, their voice conversation is carried as a stream of packets from the calling user to the called user. The packets associated with the calling user may take different paths to their destination while traversing the network. They may arrive at their destination at different times (causing “jitter”), arrive out of sequence, or possibly not arrive at all. At the destination, however, these packets are reassembled and converted back into voice signals for the called user. The VoIP technology ensures proper reconstruction of the voice signals, compensates for echoes (that are made audible due to the end-to-end delay), corrects jitter, and appropriately handles situations where packets do not reach their destination.

However VoIP is a relatively new technology, and is currently not able to replace the circuit switched PSTN completely. Hence, in contemporary networks, VoIP networks have replaced portions of the PSTN, to provide PSTNs the added advantage of packet switching. In such contemporary networks, VoIP networks have to talk to both the SS7 network for call signaling, and to the circuit switched network for voice signaling. Such an interfacing is achieved using VoIP gateways, which convert voice signals and call signals from the PSTN to data packets for the IP network, and vice versa.

There are two types of VoIP Gateways: Signaling Gateways (SGs) and Media Gateways (MGs). SGs convert SS7 protocol packets to IP packets, and vice versa. Similarly, MGs convert voice signals carried by the PSTN to Real Time Protocol (RTP) packets for the IP network, and vice versa. However, MGs are not “intelligent” and need to be instructed. Such instructions are given by elements known as Media Gateway Controllers (MGCs), which instruct the MGs by sending them commands defined in a Media Gateway Control Protocol (MGCP).

MGCP introduces the concept of “connections” and “endpoints” in MGs. An endpoint is defined to be either a source or a sink of data. For example, an endpoint could be an MG interface that terminates a voice trunk connection from or to a PSTN switch, or an MG interface that terminates a PSTN connection from or to a phone. And, a connection is defined to be an association between two endpoints for transmitting data between them.

As mentioned earlier, in contemporary networks, VoIP networks replace portions of the PSTNs. When one user places a call to another user over such a network, the voice circuit between the calling user and the called users' switches is setup over the VoIP network. The VoIP network interfaces with these switches using MGs, wherein each MG terminates a voice trunk connection from its respective PSTN switch. Each MG has two endpoints: one, its interface with the PSTN switch, and another, its interface with the VoIP network. The MGs are controlled by an MGC using MGCP commands. The MGC instructs each MG to setup a connection between each of their endpoints, to transmit data between the endpoints. Once such connections are created within each MG, the two MGs can send voice packets to each other, thus completing the voice circuit between the two PSTN switches.

A typical sequence of MGCP commands, between an MGC and its MGs, is described below. The first MG interfaces with the PSTN switch of the calling user and the second MG interfaces with the PSTN switch of the called user. Both MGs are controlled by the same MGC.

When a voice circuit setup is initiated, the MGC determines that the first MG has to create a connection between its endpoints. To achieve this, the MGC sends a CreateConnection (CRCX) command to the first MG. CRCX is a command instructing the first MG to create a connection between its two endpoints. When the first MG receives this CRCX command, it maps its endpoint with the first PSTN switch to an IP address and User Datagram Protocol (UDP) port within the VoIP network. The first MG then responds to the CRCX command with a CreateConnection Acknowledgement (CRCX_ACK), which is an acknowledgement to the CRCX command. This CRCX_ACK command also contains “session description parameters”, which are details like the Internet Protocol (IP) address and UDP port to which the PSTN endpoint is mapped.

When the MGC receives the CRCX_ACK from the first MG, it determines that the second MG has to create a connection between its endpoints. To achieve this, the MGC sends a CRCX command to the second MG. This CRCX command carries the session description parameters provided by the first MG. When the second MG receives this CRCX command, it maps its endpoint with the second PSTN switch to an IP address and a UDP port within the VoIP network. The second MG then responds to the CRCX command with a CRCX_ACK. This CRCX_ACK command contains the session description parameters of this connection.

When the MGC receives the CRCX_ACK from the second MG, it determines that it needs to inform the first MG of the session description parameters of the second MG's connection. To achieve this, the MGC sends a ModifyConnection (MDCX) command to the first MG. MDCX is a command instructing the first MG to modify the parameters associated with one of its connection. This MDCX command carries the session description parameters provided by the second MG. The first MG responds to the MDCX command with a ModifyConnection Acknowledgement (MDCX_ACK), which is an acknowledgement to the MDCX command.

As both MGs now have each others' session description parameters, they can send voice packets to each other over the VoIP network. The first MG knows the IP address and UDP port to which the second MG has mapped the second PSTN endpoint. Thus the first MG sends voice packets for the second PSTN switch to this IP address and UDP port. Similarly, the second MG knows the IP address and UDP port to which the first MG has mapped its PSTN endpoint. Thus the second MG sends voice packets for the first PSTN switch to this IP address and UDP port. Communication between the two PSTN switches thus takes place in both directions.

In a typical scenario, MGCs control the MGs using information received from SS7 call signals of the PSTN. While the MGs interface with the voice trunks of PSTN switches, the MGCs replace the STPs of the SS7 network. Thus, the SS7 call signaling messages are sent through the MGC, while the voice circuit is setup through the IP network using the MGs. The SS7 messages initiate the seizing of the voice trunks by the PSTN switches, while the MGCP commands from the MGCs initialize the MGs.

In a scenario such as the above, it is essential for a proper setup of the call that the PSTN switches seize their voice trunks, only after the MGs are initialized. Thus, there is a need for a method that synchronizes the call signaling (i.e., the SS7 messages sent between the PSTN switches) with the voice circuit setup (i.e., the MGCP commands sent by the MGC to the MGs) over an IP network.

### SUMMARY

An object of the present invention is to provide a method for synchronizing call signaling and voice circuit setup over a Voice over Internet Protocol (VoIP) network.

Other objects and advantages of the present invention will be set forth in part in the description and in the drawings which follow and, in part will be obvious from the description or may be learned by practice of the invention.

To achieve the above objects, the following architecture, comprising a call initiating PSTN, a destination PSTN, and a Voice over Internet Protocol (VoIP) network, is used. The VoIP network has Media Gateways (MGs) that interface the VoIP network with the PSTNs, and Media Gateway Controllers (MGCs) that instruct and control the MGs using Media Gateway Control Protocol (MGCP). The PSTNs connect to the MGs over a voice trunk, and further, connect to the MGCs over a Signaling System 7 (SS7) network.

The PSTN switches send call signaling message to one another through the MGC. To synchronize the call signaling and voice circuit setup, the MGC delays the effect of these SS7 messages until it is able initialize the MGs using MGCP commands. To achieve this delay, the MGC modifies the SS7 messages from the sending PSTN switch by adding some requirements to be followed by the receiving PSTN switch before it may seize the voice circuit from its side.

### BRIEF DESCRIPTION OF THE DRAWINGS

The preferred embodiments of the invention will hereinafter be described in conjunction with the appended drawings provided to illustrate and not to limit the invention, wherein like designations denote like elements, and in which:

FIG. 1 is a block diagram illustrating a typical PSTN architecture that uses an SS7 network for call signaling.

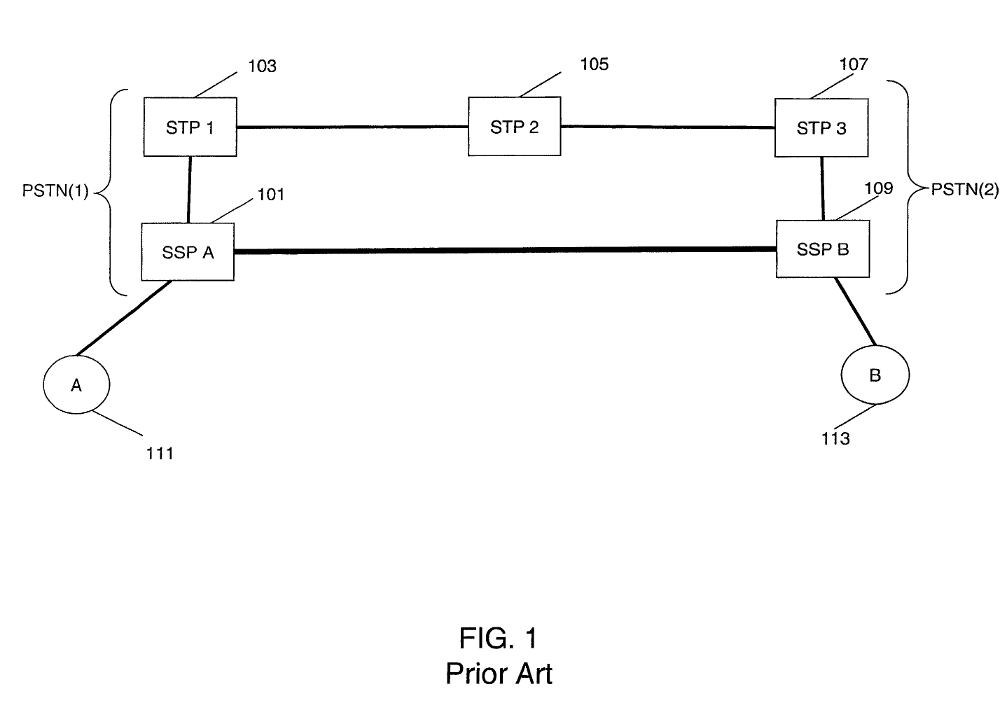

FIG. 2 is a block diagram depicting an example of a VoIP network interfacing with two PSTNs, on which the preferred embodiment of the present invention is practiced.

FIG. 3 is a timing sequence depicting an exchange of commands between various network elements of the architecture of FIG. 2, using en-bloc sequencing in a preferred embodiment of the present invention.

FIG. 4 is a timing sequence depicting an exchange of commands between various network elements of the architecture of FIG. 2, in overlap sequencing in a preferred embodiment of the present invention.

### DESCRIPTION OF PREFERRED EMBODIMENTS

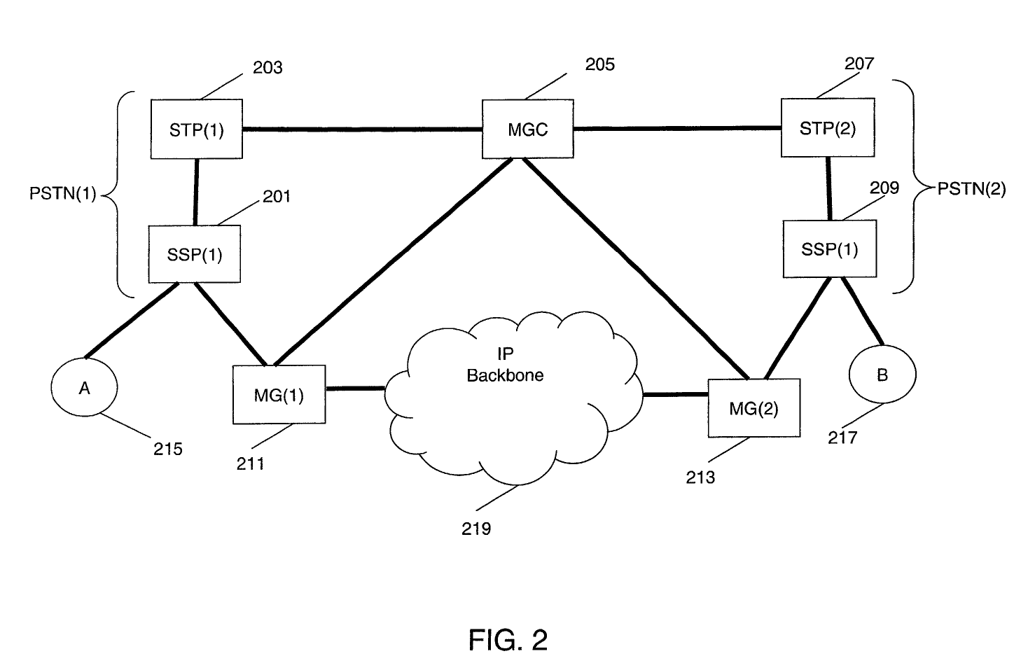

FIG. 2 is a block diagram depicting an example of a VoIP network interfacing with two PSTNs, on which a preferred embodiment of the present invention is practiced. Referring to FIG. 2, PSTN(1) is the PSTN of the calling user, and PSTN(2) is the PSTN of the called user. SSP(1) 201 and STP(1) 203 are Signal Switching Points and Signal Transfer Points, respectively, that comprise the SS7 network of PSTN(1). Similarly, SSP(2) 209 and STP(2) 207 are Signal Switching Points and Signal Transfer Points that comprise the SS7 network of PSTN(2). SSP(1) 201 has a calling user A 215 connected to it, and SSP(2) 209 has a called user B 217 connected to it.

Between PSTN(1) and PSTN(2) is a VoIP network. The main elements of this VoIP network are MG(1) 211 and MG(2) 213, which are Media Gateways that interface with SSP(1) 201 and SSP(2) 203 respectively; MGC 205, which is a Media Gateway Controller that controls MG(1) 211 and MG(2) 213; and an IP backbone 219, which is the communication backbone of the VoIP network. When calling user A 215 makes a telephone call to calling user B 217, the call passes from PSTN(1) to PSTN(2) through this VoIP network.

SSP(1) 201 and MG(1) 211, and SSP(2) 209 and MG(2) 213, are connected to each other through a voice trunk. MGC 205 is connected to MG(1) 211 and MG(2) 213 through the IP backbone 219, and it controls MG(1) 211 and MG(2) 213 through an Media Gateway Control Protocol (MGCP). MGCP defines various commands, of which the commands relevant to the preferred embodiment of present invention are discussed below.

CreateConnection (CRCX) command, which is a command sent from an MGC to an MG. This command instructs the MG to map its PSTN endpoint to a specific IP address within the VoIP network (i.e. create a connection between the PSTN endpoint and the IP address endpoint). The endpoint to be mapped, as well as various other parameters for this connection, are contained in this command. The address and port to be mapped to the endpoint are decided by the MG upon receiving this command.

CreateConnection Acknowledge (CRCX_ACK), which is an acknowledgement sent from an MG to an MGC upon receiving a CRCX command. This acknowledgement contains information regarding the IP address decided by the MG, and also a parameter known as “ConnectionID”, which identifies the created connection.

ModifyConnection (MDCX) command, which is a command sent from an MGC to an MG. This command instructs the MG to change the parameters associated with a previously established connection. The MDCX command contains the same parameters as the CRCX command, but for the “ConnectionID” parameter, which identifies the connection to be modified.

ModifyConnection Acknowledge (MDCX_ACK), which is an acknowledgement sent from an MG to an MGC upon receiving a MDCX command.

Referring once again to FIG. 2, STP(1) 203, MGC 205, and STP(2) 207 are interconnected through a SS7 signaling link. This link is used for carrying the SS7 call signaling messages exchanged between SSP(1) 201 and SSP(2) 209. As MGC 205 is a part of the “STP(1) 203-MGC 205-STP(2) 207” signaling link, it uses information in the SS7 call signaling messages to control and instruct the MGs using MGCP

SS7 call signaling messages are based on an SS7 protocol, which defines various messages. The messages relevant to the preferred embodiment of present invention are as discussed below.

Initial Address Message (IAM), which is a message sent from an initiating switch to a destination switch, and serves to initiate a call between the two switches. This message contains information regarding various call setup details like the initiating switch, the destination switch, the voice circuit selected, and the calling as well as called numbers. Upon receiving this message, the destination switch seizes the voice circuit from its side, and connects the called user to this voice circuit.

The IAM may also include requirements to be satisfied by the destination switch before it may seize the voice circuit. For example, the destination switch may be required by an initiating switch to pass a continuity test. In a test, the destination switch loopbacks its voice circuit with the initiating switch. Next, the initiating switch sends a tone on the voice circuit and if the “loopbacked” tone is the same as the sent tone, the continuity test is declared passed. To indicate that the results of a continuity test, the initiating switch sends a continuity Message (COT) to the destination switch, following which the destination switch seizes its side of the voice circuit.

It is also possible that an IAM message does not contain all the digits of the called number. In such a scenario, the destination switch does not seize the voice circuit from its side, until it receives the remaining digits. These remaining digits are usually sent by the initiating switch using a Subsequent Address Message (SAM).

Address Complete Message (ACM), which is a message sent from a destination switch to an initiating switch and indicates that the receipt of the IAM. This message contains information regarding various call setup details like the destination switch, the initiating switch, and the selected voice circuit. This message also indicates to the initiating switch that the destination switch has seized the voice circuit from its side.

In response to an ACM message, the initiating exchange seizes its side of the voice circuit, and also connects the calling user to this circuit.

Answer Message (ANM), which is a message sent by a destination switch to an initiating switch. This message contains information regarding various call setup details like the destination switch, the initiating switch, and the selected voice circuit. This message indicates to the initiating switch that the called user has answered the telephone call. Upon receiving this message, the initiating switch initiates a billing process.

Continuity Message (COT), which is a message sent by an initiating switch to a destination switch. This message indicates to the destination switch that a continuity test has passed or failed.

Subsequent Address Message (SAM), which is a message sent by an initiating switch to a destination switch. This message contains the remaining digits of the called number.

Referring to the IAM, it may be noted that there are two different modes to this message. In one mode, a continuity check requirement is set on the destination switch, while in another mode, only a minimum number of the digits of the called number are sent. These two modes imply two different sequences in which SS7 messages maybe sent, to setup a voice circuit between an initiating switch and a destination switch. These two signaling sequences are respectively known as “en-bloc” and “overlap” sequencing. The preferred embodiment of present invention uses these two forms of sequencing as a means to delay the activities of SSP(2) 209 (of PSTN(2)), so that MGC 205 can initialize MGs 211 and 213 using MGCP.

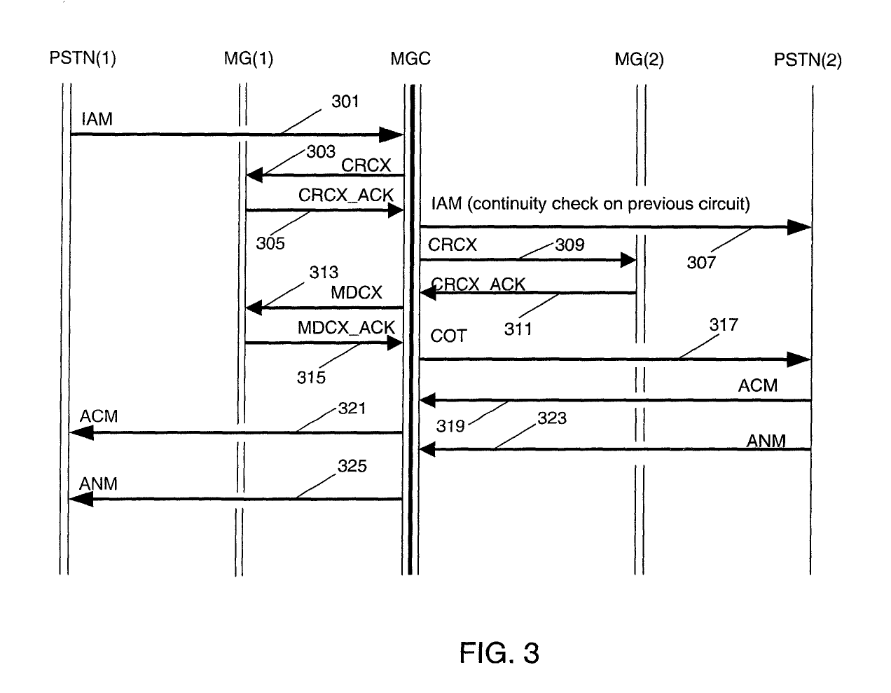

FIG. 3 is a timing sequence depicting the exchange of commands between various network elements of the architecture of FIG. 2, using en-bloc sequencing in a preferred embodiment of the present invention. During the en-bloc sequencing the synchronizing of signaling and speech path is done as follows.

At 301, the initiating switch, SSP(1) 201, sends an IAM to MGC 205. The IAM specifies the initiating switch as SSP(1) 201 and the destination switch as SSP(2) 209. This message is sent to SSP(2) 209 using the “STP(1) 201-MGC 205-STP (2) 207” signaling link. Upon receiving the IAM, MGC 205 determines that a voice circuit has to be setup between SSP(1) 201 and SSP(2) 209. To achieve this, it has to initialize MG(1) 211 and MG(2) 213. At 303, MGC 205 sends a CRCX command to MG(1) 211.

When MG(1) 211 receives the CRCX command, it creates a connection with SSP(1)'s 201 voice circuit. At 305, MG(1) 211 responds to MGC 205 with a CRCX_ACK, which contains its session description parameters. At 307, when MGC 205 receives the CRCX_ACK from MG(1) 211, it sends an IAM to SSP(2) 209, along with a request that a continuity test has to be performed. Since a continuity test has to be performed SSP(2) 209 does not seize the voice circuit from its side. Then, at 309, MGC 205 sends a CRCX command to MG(2) 213, along with the session description parameters sent by MG(1) 211.

When MG(2) 213 receives the CRCX command, it creates a connection with SSP(2)'s 209 voice circuit. Subsequently, at 311, MG(2) 213 responds to MGC 205 with a CRCX_ACK and its own session description parameters. At 313, upon receiving the CRCX_ACK from MG(2) 213, MGC 205 sends a MDCX command to MG(1) 211, with the session description parameters sent by MG(2) 213. At 315, when MG(1) 211 receives the MDCX command, it acknowledges the command by sending a MDCX_ACK to MGC 205.

At 317, upon receiving the MDCX_ACK, MGC 205 sends a COT message to the destination switch SSP(2) 209. This message indicates to SSP(2) 209 that the continuity test has passed, and that it may now seize the voice circuit between itself and MG(2) 213, from its side.

At 319, upon receiving the COT message the destination switch SSP(2) 209 sends an ACM to MGC. At 321, MGC 205 forwards the ACM to the originating switch SSP(1) 201. At 323, the destination switch SSP(2) 209 then sends an ANM to MGC 205. At 325, MGC 205 forwards the ANM to SSP(1) 201. This completes the call setup.

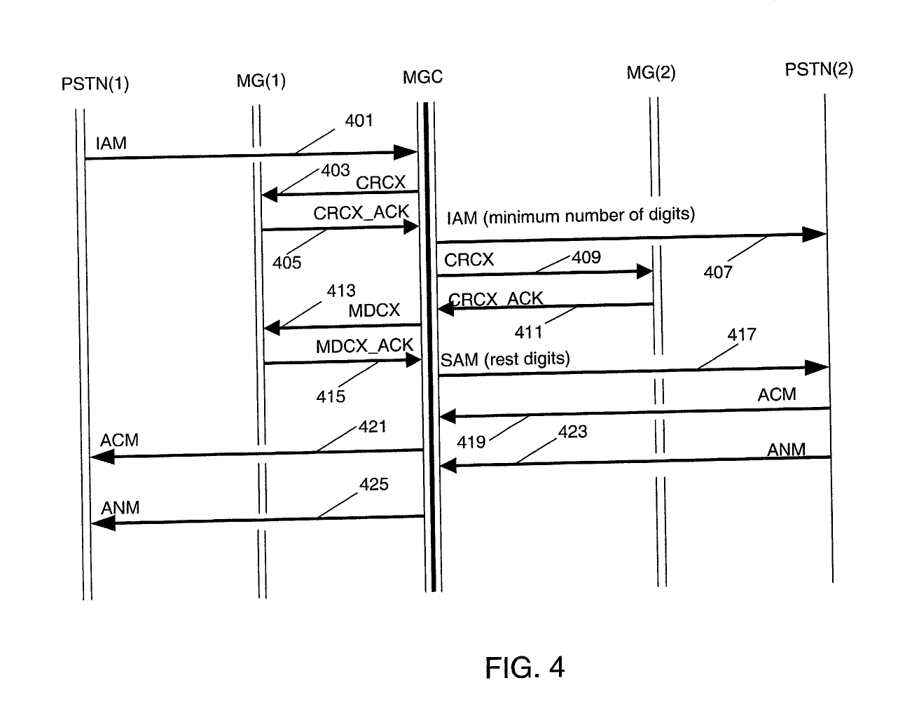

FIG. 4 is a timing sequence depicting the exchange of commands between various network elements of architecture in FIG. 2, using overlap sequencing in a preferred embodiment of the present invention. During the overlap sequencing the synchronizing of signaling and speech path is done as follows.

At 401, the initiating exchange, SSP(1) 201, sends an IAM to MGC 205. The IAM specifies the initiating exchange as SSP(1) 201 and the destination exchange as SSP(2) 209. This message is sent to SSP(2) 209 using the “STP(1) 201-MGC 205 -STP (2) 207” signaling link. Upon receiving the IAM, MGC 205 determines that a voice circuit has to be setup between SSP(1) 201 and SSP(2) 209. To achieve this, it has to initialize MG(1) 211 and MG(2) 213. At 403, MGC 205 sends a CRCX command to MG(1) 211.

When MG(1) 211 receives the CRCX command, it creates a connection with SSP(1)'s 201 voice switch. At 405, MG(1) 211 responds to MGC 205 with a CRCX_ACK, which contains its session description parameters. At 407, when MGC 205 receives the CRCX_ACK from MG(1) 211, it sends an IAM to SSP(2) 209, but only sends a minimum number of digits of the called number. Since only a minimum number of digits have been sent, SSP(2) 209 does not seize the voice circuit from its side Then, at 409, MGC 205 sends a CRCX command to MG(2) 213, along with the session description parameters sent by MG(1) 211.

When MG(2) 213 receives the CRCX command, it creates a connection with SSP(2)'s 209 voice circuit. Subsequently, at 411, MG(2) 213 responds to MGC 205 with a CRCX_ACK and its own session description parameters. At 413, upon receiving the CRCX_ACK from MG(2) 213, MGC 205 sends a MDCX command to MG(1) 211, with the session description parameters sent by MG(2) 213. At 415, when MG(1) 211 receives the MDCX command, it acknowledges the command by sending a MDCX_ACK to MGC 205.

At 417, upon receiving the MDCX_ACK, MGC 205 sends a SAM, alongwith the remaining digits of the called number, to the destination switch SSP(2) 209. This message indicates to SSP(2) 209 that the continuity test has passed, and that it may now seize the voice circuit between itself and MG(2) 213, from its side.

At 419, upon receiving the SAM the destination switch SSP(2) 209 sends an ACM to MGC. At 421, MGC 205 forwards the ACM to the originating switch SSP(1) 201. At 423, the destination switch SSP(2) 209 then sends an ANM to MGC 205. At 425, MGC 205 forwards the ANM to SSP(1) 201. This completes the call setup.

Thus, using en-bloc sequencing and overlap sequencing, the preferred embodiment of present invention ensures that SSP(2) 209 does not seize the voice circuit between itself and MG(2) 213, until MGC 205 has initialized MG(1) 211 and MG(2) 213. Once MG(1) 211 and MG(2) 213 have been initialized, SSP(2) 209 seizes its side of the voice trunk and then SSP(1) 201 seizes its side of the voice trunk. The voice circuit setup between SSP(1) 201 and SSP(2) 209 is thus completed.

While the preferred embodiments of the invention have been illustrated and described above, it will be clear that the invention is not limited to these embodiments only. Numerous modifications, changes, variations, substitutions and equivalents will be apparent to those skilled in the art without departing from the spirit and scope of the invention as described in the claims.

What is claimed is:

1. A method of synchronizing call signaling and voice path setup in a telephone call between an initiating and a destination switch passing through a packet switched network, such that said packet switched network has a first gateway interfacing with said initiating switch through a voice trunk, a second gateway interfacing with said destination switch through another voice trunk, and a gateway controller for controlling and instructing said first and second gateways, said method comprising the steps of:
a. transmitting a call initiating message from said initiating switch to said destination switch through said gateway controller, wherein said transmitting is done to initialize call setup;
b. initializing of said first gateway by said gateway controller, wherein said first gateway maps its initiating switch interface to an address within said packet switched network;
c. transmitting said call initiating message from said gateway controller to said destination switch, wherein said gateway controller has modified said call initiating message to create a delay in seizing its voice trunk by said destination switch;
d. initializing of said second gateway by said gateway controller, wherein said gateway controller sends the mapped network address of said initiating switch to said second gateway, and said second gateway maps its destination switch interface to an address within said packet switched network;
e. sending the mapped network address of said destination switch to said first gateway by said gateway controller;
f. transmitting a message from said gateway controller to said destination switch, such that said destination switch seizes said voice circuit from its side.
g. transmitting a message from said destination switch to initiating switch, such that said initiating switch seizes said voice trunk from its side and completes call setup.

2. A method as claimed in claim 1, wherein said transmitting step comprises sending an Initial Address Message from initiating switch to said destination switch through said gateway controller.

3. A method as claimed in claim 1, wherein said initializing step comprises:
a. sending a CreateConnection command by said gateway controller to said first gateway;
b. mapping the initiating exchange interface to an address within said packet switched network by said first gateway; and
c. sending a CreateConnection Acknowledgement along with the mapped network address by said first gateway to said gateway controller.

4. A method as claimed in claim 1, wherein said transmitting step comprises sending an Initial Address Message from said gateway controller to said destination switch with a continuity check requirement for said destination switch.

5. A method as claimed in claim 1, wherein said transmitting step comprises sending an Initial Address Message from said gateway controller to said destination switch with only minimum digits of dialed number.

6. A method as claimed in claim 1, wherein said initializing step comprises:
a. sending a CreateConnection command along with the mapped network address of said initiating switch by said gateway controller to said second gateway;
b. mapping the destination switch interface to an address within said packet switched network by said second gateway; and
c. sending a CreateConnection Acknowledgement alongwith the mapped network address by said second gateway to said gateway controller.

7. A method as claimed in claim 1, wherein said sending step comprises:
a. sending a ModifyConnection command alongwith with the mapped network address of said destination switch by said gateway controller to said first gateway;
b. sending a ModifyConnection Acknowledgement by said first gateway to said gateway controller.

8. A method as claimed in claim 1, wherein said transmitting step comprises sending a Continuity Test message by said gateway controller to said destination exchange, such that said destination switch seizes said voice circuit from its side.

9. A method as claimed in claim 1, wherein said transmitting step comprises sending a Subsequent Address Message alongwith the remaining digits of dialed number by said gateway controller to said destination switch, such that said destination switch seizes said voice circuit from its side.

10. A method as claimed in claim 1, wherein said transmitting step comprises:
a. sending a Address Complete Message by said destination exchange to said initiating switch through said gateway controller;
b. seizing of said voice circuit by said initiating switch from its side;
c. sending a Answer Message by said destination exchange to said initiating exchange through said gateway controller.
